(19) United States
(12) Patent Application Publication
(10) Pub. No.: US 2008/0224973 A1
(43) Pub. Date: Sep. 18, 2008

(54) Color Sequential Backlight Liquid Crystal Displays and Related Methods

(75) Inventor: Hendrik Louwsma, Heerlen (NL)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Heerlen (NL)

(21) Appl. No.: 11/686,997

(22) Filed: Mar. 16, 2007

(51) Int. Cl. G09G 3/36

(52) U.S. Cl. 345/88

(57) ABSTRACT

A color LCD arrangement with a lower substrate, an upper substrate, liquid crystal material between the lower substrate and upper substrate, and a backlight unit with light sources. The backlight unit is divided into a plurality of segments. Each segment has a light source arrangement to generate light with at least a first and a second color. The light sources are driven such that during different fields within a frame different color driving schemes for the segments are used. This provides for a spreading of the color light up both in time and in location, thus, seriously reducing the color break-up problem.

### FIELD OF THE INVENTION

The invention relates to LCD displays.

### BACKGROUND OF THE INVENTION

Color sequential backlight liquid crystal displays have not become accepted in the market due, primarily, to an artifact called color break-up. Color break-up is the phenomenon involving the ability of an observer to distinguish the different color fields, for instance, the red, green and blue fields individually, for very short periods of time. The artifact is often observed when the observer moves relative to the display, especially in case the relative movement is periodic. To solve this artifact, one may use very high frame rates (refresh frequencies) at the expense of considerable display power consumption. In turn, this poses a potentially severe requirement on the switching speed of the display.

Instead, intermediate solutions like spectrum sequential backlight LCD displays emerge. However, these displays require color filters and offer far less benefits than targeted for the color sequential backlight.

Sequential backlight LCD displays have been described in numerous publications. In these types of LCD displays, color filters typically are not needed. Such an LCD display comprises a lower substrate, an upper substrate, a liquid crystal layer in between and a red, green, blue (R, G, B) three color backlight unit. The lower substrate is an array substrate with gate lines and address lines. R, G, B light sources of the backlight unit are separately turned on and off. For instance, each of the R, G, B light sources are lit 60 times per second. So, in total they are lit 180 times per second which renders a residual effect. That is, colors are mixed as perceived by of the human eye for expressing a desired color.

The prior art also discloses edge type and direct type backlight units. In the past, it has been a problem that liquid crystals have a slow response time rendering it difficult to drive all gate lines within one frame. The so-called Divided Display Area Method (DDAM) has been developed to solve this problem. In the DDAM, the display area is divided in separate sections which are successively driven, as is generally described in US-A-2005/0140848.

### SUMMARY

Color sequential backlight liquid crystal displays and related methods are provided. In this regard, an exemplary embodiment of a color LCD arrangement comprises: a lower substrate; an upper substrate; liquid crystal material located between the lower substrate and the upper substrate; and a backlight unit having light sources and being divided into a plurality of segments, each of the segments having a light source arrangement operative to generate light with at least a first color and a second color, the light sources being operative to be driven such that, during different fields within a frame, different color driving schemes for the segments are used.

Another embodiment of a color LCD arrangement comprises: a lower substrate; an upper substrate; a liquid crystal material between the lower substrate and upper substrate; a backlight unit comprising a plurality light sources; and a processor arranged to control driving of said plurality of light sources the backlight unit being divided into a plurality of segments, each segment comprising a light source arrangement to generate light with at least a first and a second color, said processor being arranged to control said driving of said plurality of light sources such that: the LCD arrangement shows one color image within a time period equal to a frame, wherein said frame is divided into a plurality of fields; during each field, in each segment the light source arrangement is driven to produce light of only one of said at least first and second colors; during each field, light source arrangements in different segments are arranged to produce light such that any of said at least first and second colors lights up in at least one segment; and during at least one field, light source arrangements in said segments are driven to produce light in accordance with a different color driving scheme than during at least one other field during said frame.

An embodiment of a method of driving a color LCD arrangement comprising a lower substrate, an upper substrate, liquid crystal material between the lower substrate and upper substrate, a backlight unit comprising a plurality light sources, the backlight unit being divided into a plurality of segments, each segment comprising a light source arrangement to generate light with at least a first and a second color, the method comprising: showing one color image, with the LCD arrangement, within a time period equal to a frame, wherein said frame is divided into a plurality of fields; during each field, in each segment, driving the light source arrangement to produce light of only one of said at least first and second colors; during each field, producing light with light source arrangements in different segments such that any of said at least first and second colors lights up in at least one segment; and during at least one field, driving the light source arrangements in said segments are driven to produce light in accordance with a different color driving scheme than during at least one other field during said frame.

### BRIEF DESCRIPTION OF THE DRAWINGS

The invention will be explained in detail with reference to some drawings that are only intended to show embodiments of the invention and not to limit the scope. The scope of the invention is defined in the annexed claims and by its technical equivalents.

The drawings show:

FIG. 1 shows a schematic view of an embodiment of a backlight LCD arrangement;

FIG. 2 shows a top sectional view of the embodiment of the LCD arrangement of FIG. 1 along line II-II in FIG. 1;

FIG. 3 shows an addressing scheme of a conventional RGB (red, green, blue) backlight LCD;

FIG. 4 shows an addressing scheme of a RGB (red, green, blue) backlight LCD in accordance with a first embodiment;

FIG. 5 shows a schematic view of an LCD segmented into three segments extending parallel to the address lines of the LCD;

FIG. 6 shows an addressing scheme of an RGB (red, green, blue) backlight LCD in accordance with a second embodiment;

FIG. 7 shows a schematic view of an LCD segmented into three segments extending parallel to the address lines of the LCD, where each segment is sub-divided into three sub-segments spread over the surface of the LCD;

FIG. 8 shows a schematic view of an LCD segmented into nine segments extending parallel to the address lines of the LCD;

FIG. 9 shows an addressing scheme for the backlight LCD of FIG. 8;

FIG. 10 shows a schematic view of an LCD segmented into three segments extending perpendicular to the address lines of the LCD;

FIG. 11 shows an addressing scheme for the backlight LCD of FIG. 10;

FIG. 12 shows a schematic view of an LCD segmented into nine segments arranged in a matrix of three times three segments;

FIGS. 13 and 14 show an addressing scheme for the backlight LCD of FIG. 12.

### DETAILED DESCRIPTION OF EMBODIMENTS

Reference is now made to several exemplary embodiments in which the backlight LCD is segmented. This can be done in a number of ways. Each segmentation potentially has an impact on the display addressing. Horizontal segmentation can be applied in backlight systems using light guides as well as direct lit backlights. In such systems, the light colors are emitted either sequentially or simultaneously.

For vertical and vertical plus horizontal (i.e. blocked) segmented backlights, again applicable for both direct lit backlight (either LED or OLED) and indirect lit backlights (e.g. light guide combined with side firing LEDs or CCFL (Cold Cathode Fluorescent Lamp)), the light colors are emitted simultaneously for the various segments. In all cases, the spatial and temporal distribution of the various segments can reduce the color break-up artifact and potentially offer all the benefits of color sequential backlights.

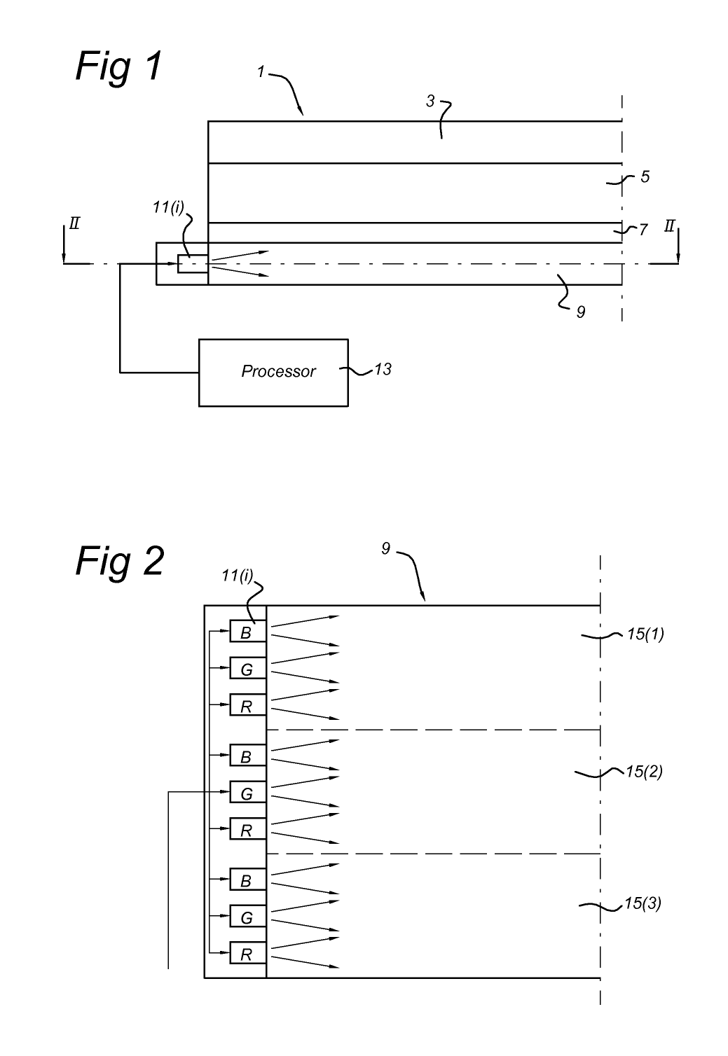

FIG. 1 shows a side cross sectional view of an embodiment of a color sequential backlight LCD 1. The color sequential backlight LCD 1 comprises a backlight unit 9 below a lower substrate 7. Above the lower substrate 7 there is an upper substrate 3, and between the lower and upper substrates 3, 7 there is provided liquid crystal material 5. The lower substrate 7 is an array substrate with gate lines and data lines that are connected to a suitable driving unit. These gate and data lines, as well as other details of the LCD and the driving unit are not shown. They are known to persons skilled in the art. Moreover, any known (and future) implementation for these components may be applied in the present invention. As known to persons skilled in the art, the driving unit is arranged to drive the gate lines and data lines such that individual pixels in the LCD can be selected such that the selected pixels do or do not, or only partially, transmit light from backlight unit 9 to upper substrate 3. By proper selection of pixels, individual images can be generated and shown to a user. By consecutive selections of series of pixels in the LCD, movies can be displayed.

The backlight unit 9 comprises a plurality of light sources 11(i), i=1, 2, . . . , I, where I/3 is an integer value. FIG. 1 shows that a processor 13 is connected to the light sources 11(i). The processor 13 is preferably a microprocessor with memory storing one or more computer programs with data and instructions arranged so as to provide the processor 13 with the capacity to perform some desired functions. Such a processor 13 is known in the art. There are no restrictions as to its implementation for the present invention.

FIG. 2 shows a cross section along line II-II in FIG. 1. FIG. 2 shows that the plurality of light sources 11(i) comprises 9 light sources. The light sources are all connected to processor 13 and are grouped in 3 groups. Each group has one red light source R, one green light source G, and one blue light source B. As will be explained below, the R, G, B light sources 11(i) are lit consecutively within each group by processor 13. Moreover, groups are consecutively lit by processor 13. Each one of the groups of R, G, B light sources corresponds to one segment 150), j=1, 2, . . . , J. These segments may or may not be arranged such that light generated within one segment 150) can or cannot reach an adjacent segment 150). For instance, reflecting surfaces may be applied between adjacent segments 15a).

It is observed that FIG. 2 shows that each segment comprises as many light sources as there are different colors. However, the invention is not restricted to this configuration. The invention includes embodiments in which each segment has one or more light sources that are capable of consecutively generating all differently colored light radiation. For instance, so-called 3-in-1 LED arrangements can be used in which three differently colored light sources are arranged within one housing.

First, the light sources control by processor 13 of an LCD panel with only one section with a conventional RGB stripe pixel array will be explained. It is observed that the invention is also applicable for other possible pixel configurations and backlight colors, i.e. RGBW (red, green, blue, white) and GM (green-magenta) pixel configurations as well as backlight LCDs using a different set of colors than RGB.

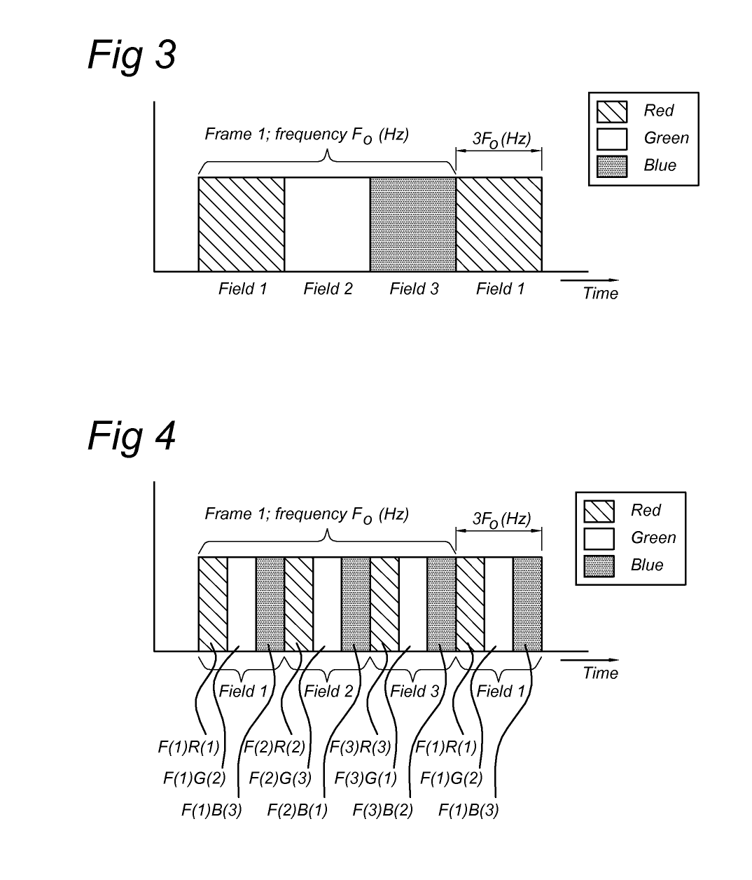

FIG. 3 shows the most straightforward configuration of an RGB color sequential backlight: red R, green G and blue B image content is displayed sequentially. In most applications, the 3 fields in which the red R, green G and blue B light sources emit light are fixed with respect to timing and sequence. In FIG. 3, a field is the time in which one of the light sources emits light. Three consecutive RGB fields correspond to a single frame. One frame equals the time in which one picture of a movie is shown. So, a frame corresponds with 1/60 sec if the refresh rate of the display is 60 Hz.

After the LCD display is addressed with the red data, the backlight emits red light. After the green data is submitted, the backlight will emit green light, etc. Typically the refresh rate Fₒ in TFT LCD displays is about 60 Hz. However, the invention is not limited to this example. A display using a color sequential backlight will thus need a refresh rate of about 180 Hz for the R, G and B fields respectively.

Drawback of above implementation is that color break-up may occur. Color break-up is the phenomenon that an observer can distinguish the color fields, for instance, the red, green and blue fields individually, for very short periods of time. The artifact is often observed when the observer moves relative to the display, especially in case the relative movement is periodic. To solve this artifact, one may use very high frame rates (refresh frequencies) at the expense of considerable display power consumption. For example, the frame frequency can be set 1.5 to 2 times higher than the before mentioned 180 Hz. In turn, this poses a severe requirement on the switching speed of the display.

To avoid color break-up, a segmented color sequential backlight LCD is used. The idea is to address not the whole display simultaneously with the red, green and blue fields, but only parts or segments of the display. In fact, the whole display is illuminated within 3 fields with red, green and blue, however, the red, green and blue illuminated segments across the display are illuminated out of phase. This basic idea is explained with reference to FIG. 4.

FIG. 4 shows an addressing scheme of the segmented RGB backlight LCD. Here, a field is redefined. In FIG. 4, a field equals the time needed to drive at least three differently colored light sources 11(i) consecutively, each light source 11(i) illuminating a different (set of segment(s) 150). As the person skilled in the art will understand, this definition should be amended for arrangements with less or more differently colored light sources. So, within a field, one (set on segment(s) 150) of the LCD display is illuminated with only one of the three different colors. Each field is divided into as many sub-fields as there are different colored light sources. So, field k (k=1, 2, . . . , K) comprises three sub-fields in FIG. 4. The sub-fields in field k in which the red light source in segment 150) is driven are indicated by F(k)R(j). The sub-fields in field k in which the green light source in segment 150) is driven are indicated by F(k)G(j). The sub-fields in field k in which the blue light source in segment 150) is driven are indicated by F(k)B(j). Three consecutive fields correspond to a single frame in which each display segment is addressed and illuminated with the RGB data and light respectively. The three different light sources 11(i) in the three adjacent segments 150) are driven such that within one single frame each light source 11(i) within a single segment 150) is driven only once. Moreover, within a field k not all light sources 11(i) within a single segment 15a) are driven. In the embodiment of FIG. 4, within a field k only one light source 11(i) is driven in one single segment 150). Thus, driving the distinct light sources 11(i) is spread over the LCD display area which reduces the color break-up artifact.

When there are less or more than three different color light sources 11(i) the definitions will change. In general, a frame is defined as the time needed to display one image of a movie. The LCD display is divided in Y segments. Each one of the Y segments has a plurality of light sources, i.e., one of each different color. Each frame is divided into as many fields as there are differently colored light sources. In each field, at least one color light source in each segment is driven by processor 13. The order in which light sources are driven consecutively in each field and consecutively per field in a frame is such that each light source is driven at least once. Moreover, preferably, per field the processor 13 drives at least one light source of all differently colored light sources. To obtain the required improvement as to color break-up, at least one of the order in which differently colored light sources are driven differs per consecutive field within one frame and the order in which consecutive segments are driven differs per consecutive field.

FIG. 4 shows an example in which, in field 1, during sub-field F(1)R(1), the red light source in segment 15(1) is driven, during sub-field F(1)G(2), the green light source in segment 15(2) is driven, and during sub-field F(1)B(3), the blue light source in segment 15(3) is driven. In field 2, during sub-field F(2)R(2), the red light source in segment 15(2) is driven, during sub-field F(2)G(3), the green light source in segment 15(3) is driven, and during sub-field F(2)B(1), the blue light source in segment 15(1) is driven. In field 3, during sub-field F(3)R(3), the red light source in segment 15(3) is driven, during sub-field F(3)G(1), the green light source in segment 15(3) is driven, and during sub-field F(3)B(2), the blue light source in segment 15(1) is driven.

As a consequence, the color break-up is limited within the assigned segments. The smaller the segments, the more effective the color break-up is masked as the red, green and blue segments are not addressed at the same time over the entire display area.

Various segmentations of the backlight LCD are possible. Of course, one can increase or decrease the number of segments.

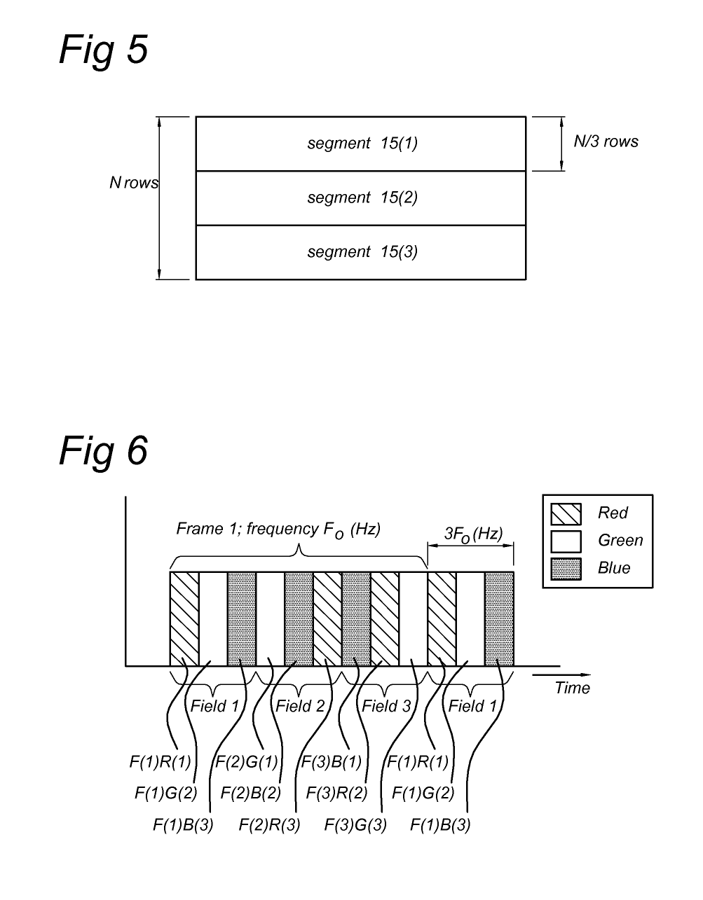

In one embodiment, the segmented color sequential backlight LCD has its segments parallel to the LCD display addressing lines (also called “rows”). The LCD displays' number of rows N is divided into m segments parallel to the LCD displays' addressing lines. See for example FIG. 5 in which m=3. The larger the number of m, the less visible the color break-up will be. The switching speed will, however, pose a limit on the number of segments.

For the first field 1, the upper third rows of the LCD display are addressed for the red data, according the scheme depicted in FIG. 4. After addressing of the rows of segment 15(1), the backlight emits red light in segment 1. After that, the middle third of the rows, i.e. segment 15(2), is addressed with the green data, after which the backlight emits green light into segment 2. Finally, the blue data is sent to segment 15(3) followed by the backlight unit 9 emitting blue light for the third segment 15(3). As a person skilled in the art knows this addressing and illuminating is in most cases nowadays based on a flash mechanism. Now field 1 is completed.

According to FIG. 4, field 2 will start with addressing segment 15(2) with red data followed by the backlight unit 9 illuminating segment 15(2) with red light. Field 3 will start with addressing segment 15(3) with the red data. After 3 consecutive fields, all rows have been addressed and illuminated with RGB data and RGB light colors respectively.

In accordance with the invention, however, alternative addressing schemes can be used. For instance, field 2 can start with addressing segment 15(1) with the green data. In field 3, segment 15(1) can start with the blue data. Again, after 3 consecutive fields, all rows have been addressed with RGB data and light colors respectively. This alternative scheme is depicted in FIG. 6.

So, in the alternative embodiment of FIG. 6, the following addressing scheme is used:
field 1:
   F(1)R(1), i.e., red light source in segment 15(1) in subfield 1;
   F(1)G(2), i.e., green light source in segment 15(2) in subfield 1;
   F(1)B(3), i.e., blue light source in segment 15(3) in subfield 1;
field 2:
   F(2)G(1), i.e., green light source in segment 15(1) in subfield 2;
   F(2)B(2), i.e., blue light source in segment 15(2) in subfield 2;
   F(2)R(3), i.e., red light source in segment 15(3) in subfield 2;
field 3:
   F(3)B(1), i.e., blue light source in segment 15(1) in subfield 3;
   F(3)R(2), i.e., red light source in segment 15(2) in subfield 3;
   F(3)G(3), i.e., green light source in segment 15(3) in subfield 3;

Three consecutive fields correspond to a single frame in which each segment 150) is addressed and illuminated with the RGB data and RGB light respectively.

The advantage of the scheme of FIG. 4 over the one shown in FIG. 6 is that the backlight colors appear in a fixed sequence on the display. However, this is at the expense of the row addressing order.

The advantage of the scheme of FIG. 6 is that the row addressing order is as in conventional LCD displays, i.e., the red, green, and blue light sources are driven in this order in each one of the segments 15(j) in consecutive fields (of course, the scheme may start with another color than red, and may be different). The backlight color sequence is somewhat less interwoven than that in FIG. 4. However, it is still much more interwoven than the conventional scheme shown in FIG. 1.

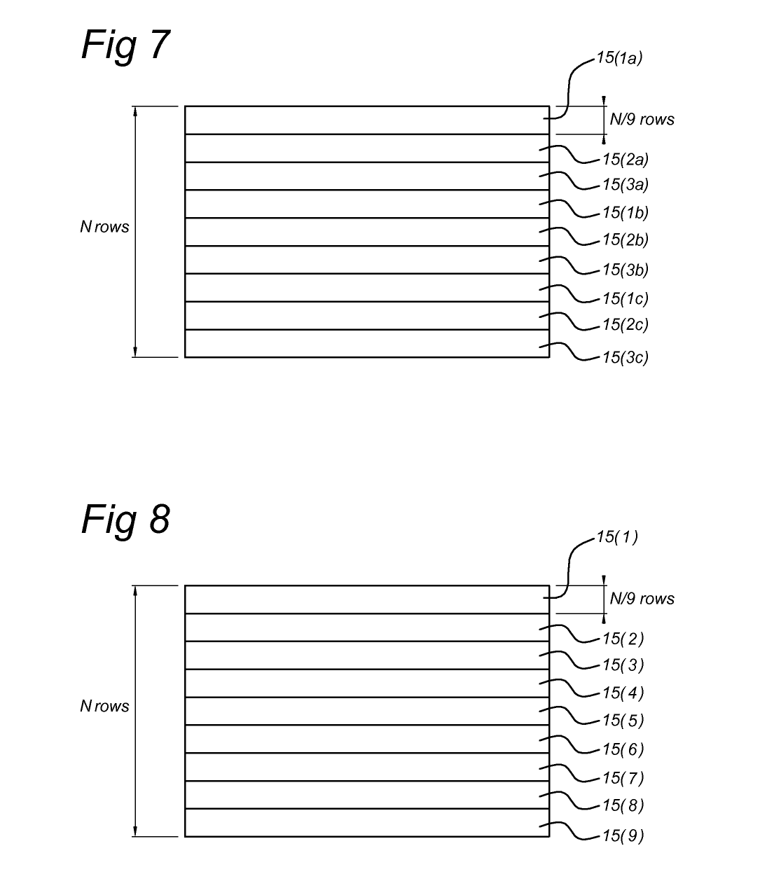

Other alternatives are possible. Evidently, one can easily change the display and backlight segmentation to the one depicted in FIG. 7.

In the alternative segmentation of FIG. 7, the LCD display and backlight are divided into 3 segments, parallel to the LCD displays' addressing lines. Segments are divided into sub-segments and located dispersed over the display area. I.e., segment 15(1) is divided into sub-segments 15(1a), 15(1b) and 15(1c). Similarly, segment 15(2) is divided into sub-segments 15(2a), 15(2b) and 15(2c), and segment 15(3) is divided into sub-segments 15(3a), 15(3b) and 15(3c). The order in which they are arranged in FIG. 7 is: 15(1a), 15(2a), 15(3a), 15(1b), 15(2b), 15(3b), 15(1c), 15(2c), and 15(3c).

In field 1, first the LCD driving unit addresses the display segments and then processor 13 drives the light sources and, thus, illuminating the sub-segments 15(1a), 15(1b), 15(1c), either according to the scheme proposed in FIG. 4 or according to the scheme proposed in FIG. 6. That is, segment 15(1) now includes three sets of row lines within three sub-segments, with each set of row lines within a sub-segment not being connected to the other sets of row lines within the other sub-segments in the same segment. Note that the row line addressing sequence is dictated by the row line assignment to the segments, i.e. the rows are not addressed from top to bottom of the LCD display.

If the scheme of FIG. 4 is used, first, in field 1, the row lines in sub-segments 15(1a), 15(1b), 15(1c) are addressed and sub-segments 15(1a), 15(1b), 15(1c) are illuminated with red light. Then, still in field 1, the row lines in sub-segments 15(2a), 15(2b), 15(2c) are addressed and sub-segments 15(2a), 15(2b), 15(2c) are illuminated with green light. Then, still in field 1, the row lines in sub-segments 15(3a), 15(3b), 15(3c) are addressed and sub-segments 15(3a), 15(3b), 15(3c) are illuminated with blue light. After that, in field 2, the order in which the backlight unit 9 supplies red, green and blue light remains the same as in field 1, however, the order of addressing the segments differs: red light is supplied to segments 15(2a), 15(2b), 15(2c), then green is supplied to segments 15(3a), 15(3b), 15(3c), and then blue light is supplied to segments 15(1a), 15(1b), 15(1c). Again, in field 3, the order in which the backlight unit 9 supplies red, green and blue light remains the same as in field 1, however, the order of addressing the segments differs: red light is supplied to segments 15(3a), 15(3b), 15(3c), then green is supplied to segments 15(1a), 15(1b), 15(1c), and then blue light is supplied to segments 15(2a), 15(2b), 15(2c).

It is observed that in this embodiment, the sub-segments within one single segment need not be lit exactly at the same moment in time. There may be a slight delay between consecutive sub-segments within a single segment.

Assigning the LCD display rows to segments in the way as shown in FIG. 7 will reduce the visibility of color break-up more effectively than the segmentation proposed in FIG. 5. It poses, however, more requirements on the design of backlight unit 9 in order to realize appropriate colors in each segment and/or sub-segment. For instance, in general more light sources may be needed. Each sub-segment may need a separate set of three differently colored light sources.

Note also the difference of the segmentation proposed in FIG. 7 with the segmentation shown in FIG. 8. In FIG. 8, the number of segments is increased, whereas in FIG. 7 there are still basically three segments.

The segmentation depicted in FIG. 8 has the advantage that the rows are addressed in the conventional way, i.e. from top to bottom of the display.

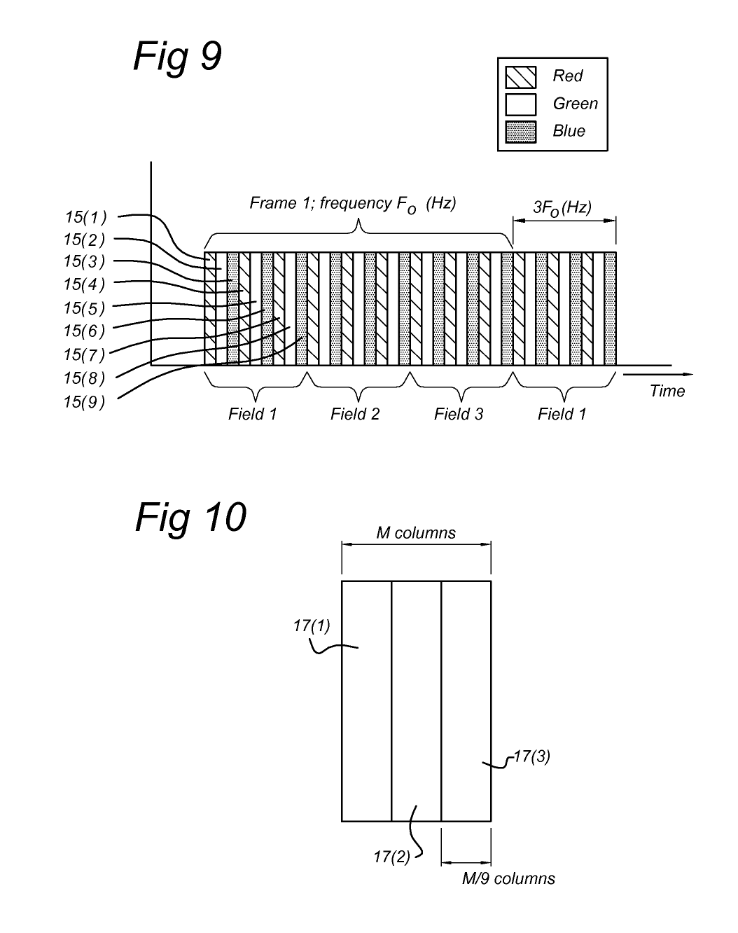

FIG. 9 shows an example of an addressing scheme for the LCD setup shown in FIG. 8. Within each field, the display is illuminated 3 times with 3 different colors. Each color applies to a different display segment. Three consecutive fields correspond to a single frame in which each display segment is addressed and illuminated with the RGB data and light respectively. In other words, in FIG. 9, each field comprises three sub-fields where consecutive sub-fields are driven by processor 13 in the same way as the fields in FIG. 4. Alternatively, the driving scheme of FIG. 6 could be employed to the sub-fields instead.

In the above examples, 3 colored backlight LCD's having R, G and B colors are discussed. Of course, the idea is also valid for backlights emitting 2, 4 or even more different colors. Besides, one can easily apply the idea to other than RGB stripe pixel configurations.

Above examples show segmentations parallel to the displays' addressing lines, i.e., parallel to the rows. This is convenient for conventional displays in landscape format with LEDs positioned to the left or right side of the display (left and right being defined relative to the row direction). These side firing LEDs in combination with a light guide plate are often found in mobile applications like mobile phones, digital still camera's (DSCs) and personal digitial assistants (PDAs).

Also direct lit LED or OLED backlight LCDs can apply the above horizontal segmentation. Direct lit LED backlight LCDs are more and more applied in LCD TV and LCD monitor applications.

For displays in portrait mode, one can segment the displays vertically, i.e. parallel to the displays' data lines, i.e., parallel to the columns, as indicated in FIG. 10. In this configuration, LED's are often positioned at the bottom or top of the display module (bottom and top being defined relative to the column direction).

FIG. 10 shows three segments 17(1), 17(2), 17(3). Evidently, one can increase or decrease the number of vertical segments as in the case of horizontal segments. Also sub-segmentation as explained above is applicable for vertical oriented segments.

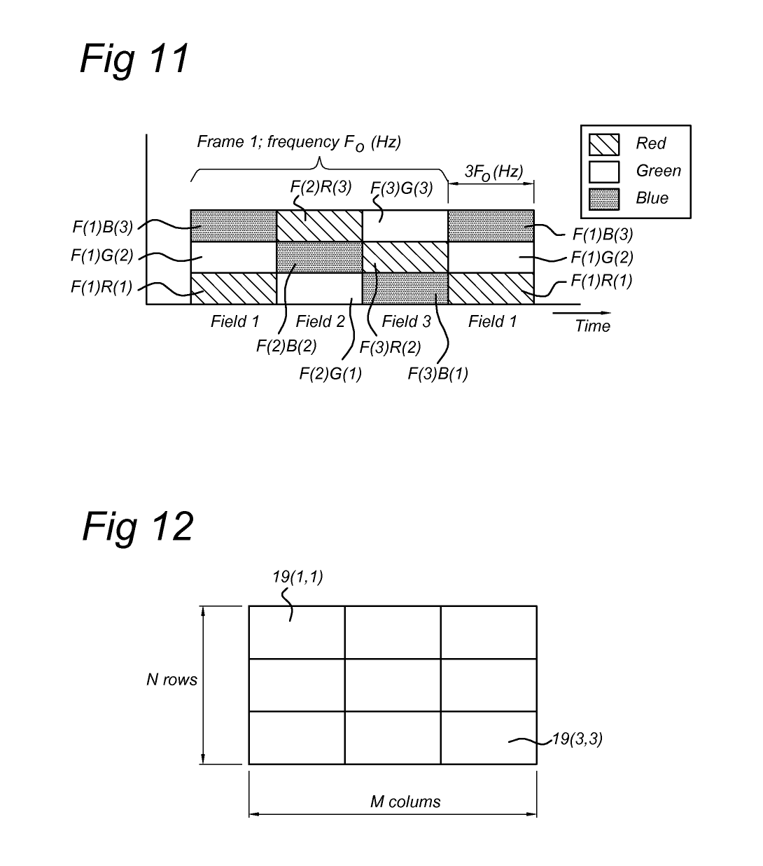

The segmented backlight LCD addressing, however, differs from that of the horizontally segmented backlight as described above. In the vertically segmented display, as the displays' rows (gate lines) are selected by the driving unit, the three color light sources 11(i) should emit their colored light simultaneously within the different segments. That is, as controlled by processor 13, segment 17(1) is illuminated with red light whilst at the same time segment 17(2) is illuminated with green light and segment 17(3) with blue light. During these periods, the columns of segment 17(1) supply the red display data, segment 17(2) the green display data and segment 17(3) the blue display data. After one field, segment 17(1) is illuminated with green light, etc. Reference is made to FIG. 11 for the complete backlight-addressing scheme.

In the embodiment of FIG. 10, the LEDs may be switched on a longer time than in the earlier embodiments. So, they may be driven with longer pulses with smaller amplitude, which may result in an simpler implementation.

FIG. 11 shows an example of an addressing scheme of the vertically segmented RGB backlight LCD according to FIG. 10 in which different colors are illuminated simultaneously rather than sequentially in time. Within a field, the display is illuminated with the 3 different colors. Each color applies to a different display segment, indicated by the index to the color R( . . . ), G( . . . ), B( . . . ). Three consecutive fields correspond to a single frame in which each display segment 17(1), 17(2), 17(3) is addressed and illuminated with the RGB data and light respectively.

The above-described backlight, which emits different colors of light simultaneously, preferably has very sharp separations between the different segments. In case a light guide configuration is used, one may use a light guide which includes say 3, separate light guides corresponding to each segment. The edges of these light guides preferably absorb or reflect light in order to avoid light and hence color mixing between adjacent light guides. Another option is to use an OLED backlight, which can be easily segmented according to the segmentation given in FIG. 10.

Note that the advantages of this simultaneous illumination of the segments 17(1), 17(2), 17(3) is that the backlight emission time is much longer than for the schemes shown in FIGS. 4 and 6. As a consequence, the backlight pulses as sent by processor 13 to the light sources 11(i) can be lower in amplitude. The color break-up is effectively suppressed as the segments 17(1), 17(2), 17(3) have different colors at a given time period, i.e. the colors are out of phase for the different segments 17(1), 17(2), 17(3).

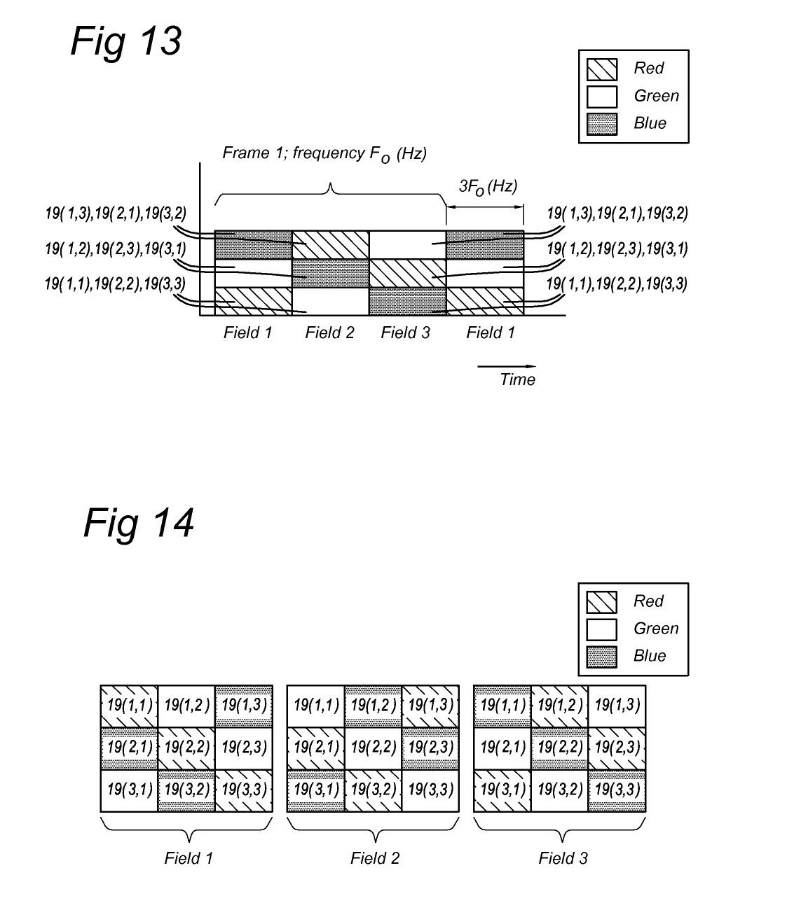

Moreover, the spatial mixing can be exploited even further by the segmentation shown in FIG. 12 which shows segments arranged in a matrix arrangement. The segments are indicated with reference sign 19(s, t), where s=1, 2, . . . , S; m=1, 2, . . . , T. In FIG. 12, the N rows of address lines of the backlight LCD are divided into 3 (S=3) segments and the M columns of gate lines are divided into 3 (T=3) segments as well. FIG. 13 shows an example of a driving scheme of the corresponding segmented backlight LCD, whereas FIG. 14 shows the LCD display and backlight colors as function of time, i.e. in the 3 consecutive fields of one frame.

The last implementation can be realized easily by using an OLED backlight. Since OLED backlight LCDs are based on a direct lit arrangement they are easily segmented according to FIG. 12. The number of segments 19(s,t) can be increased to suppress the color break-up even further or to save power by lowering the driving frequencies (frame rates). Also direct lit LED backlight LCDs can be segmented corresponding to this implementation, though the segment boundaries are more difficult to realize such that they do not overlap and do not show gaps between adjacent segments 19(s,t).

The above considerations apply to different pixel configurations (number of color filter pigments) as well as to different backlight colors and number of colors.

The spatial and temporal mixing methods and the segmented sequential backlight LCD arrangements as described above for both the horizontally and vertically segmented backlight LCDs, as well as the segmented backlight LCDs in accordance with the arrangement of FIGS. 12-14 in which the different light colors are emitted simultaneously across the various segments 19(s,t), potentially solve the color break-up problem and hence enable segmented color sequential and segmented color simultaneous backlights. A common feature to all of the arrangements explained above is that during different fields within a frame different color driving schemes for the segments can be used.

One perceived benefit is that color sequential backlight LCD displays do not need any color filters. This can reduce the cost of LCD displays and increase the brightness tremendously (factor 3). Moreover, the number of columns may be reduced with a factor 3 as sub-pixels are no longer needed. The pixels' aperture ratio increases dramatically, thereby further increasing the brightness. The lower number of columns will make the driver IC cheaper as less outputs are required to drive the LCD display. Also the color gamut will increase by using multi colored LEDs or other light sources. Moreover, the backlight power may be reduced significantly since there is no color filter needed anymore which drastically reduces light absorption. Finally, motion portrayal can be improved.

A benefit of segmentation in the direction parallel to the row (or address) lines is that this particular segment in the display can be addressed with the appropriate (color) data and flashed by the appropriate backlight color in sequence, before starting to address the next segment. Doing so, the requirement on the display switching speed is less tight than for segmentations perpendicular to the scan direction, e.g. FIG. 10. In the latter case, all rows are selected prior to flashing the backlight segments.

The invention can be applied in any product containing an LCD display. The invention is applicable for TV and monitor displays as well as for displays meant for automotive, telecom, gaming and other consumer electronics applications like DSC's and PDA's.

A common feature to all of the exemplary arrangements explained above is that during different fields within a frame different color driving schemes for the segments are used. This provides for a spreading of the color light up both in time and in location, thus, seriously reducing the color break-up problem With the appearance of, for instance, OLED (Organic Light Emitting Diode) displays, which are applicable as a backlight for LCD displays, these devices can be segmented. Also, segmentation of light guides can potentially enable color sequential and color simultaneous backlights without suffering from color break-up.

1. A color LCD arrangement comprising
a lower substrate;
an upper substrate;
a liquid crystal material between the lower substrate and upper substrate;
a backlight unit comprising a plurality light sources; and
a processor arranged to control driving of said plurality of light sources the backlight unit being divided into a plurality of segments, each segment comprising a light source arrangement to generate light with at least a first and a second color, said processor being arranged to control said driving of said plurality of light sources such that:
the LCD arrangement shows one color image within a time period equal to a frame, wherein said frame is divided into a plurality of fields;
during each field, in each segment the light source arrangement is driven to produce light of only one of said at least first and second colors;
during each field, light source arrangements in different segments are arranged to produce light such that any of said at least first and second colors lights up in at least one segment; and
during at least one field, light source arrangements in said segments are driven to produce light in accordance with a different color driving scheme than during at least one other field during said frame.

2. The color LCD arrangement according to claim 1, wherein the lower substrate is an array substrate with gate lines and data lines, the data lines extending in a first direction and the gate lines extending in a second direction perpendicular to the first direction, and the segments extending in said first direction.

3. The color LCD arrangement according to claim 1, wherein the lower substrate is an array substrate with gate lines and data lines, the data lines extending in a first direction and the gate lines extending in a second direction perpendicular to the first direction, and the segments extending in said second direction.

4. The color LCD arrangement according to claim 2, wherein each field is sub-divided into sub-fields and the processor is operative to drive the light source arrangements in the segments such that during each sub-field light of only one color is produced in one single segment.

5. The color LCD arrangement according to claim 1, wherein the lower substrate is an array substrate with gate lines and address lines, the address lines extending in a first direction and the gate lines extending in a second direction perpendicular to the first direction, and the LCD arrangement comprising a matrix of segments with a first plurality of segments extending in said first direction and a second plurality of segments extending in said second direction.

6. The color LCD arrangement according to claim 2, wherein each field is sub-divided into sub-fields and the processor is operative to drive the light source arrangements in the segments such that during each sub-field in different segments light of different colors is produced.

7. The color LCD arrangement according to claim 1, wherein the LCD arrangement comprises one of a red, green, blue pixel configuration, a red, green, blue, white pixel configuration, and a green, magenta pixel configuration.

8. The color LCD arrangement according to any preceding claim, wherein the processor is operative to drive the light sources such that each frame is divided into three fields.

9. The color LCD arrangement according to claim 1, wherein the processor is operative to control said driving of said plurality of light sources such that light is only produced during a part of said at least one field.

10. The color LLD arrangement according to claim 1, wherein, during said frame, light source arrangements in said segments are driven to consecutively produce all of said at least first and second colors within each segment.

11. A method of driving a color LCD arrangement comprising a lower substrate, an upper substrate, liquid crystal material between the lower substrate and upper substrate, a backlight unit comprising a plurality light sources, the backlight unit being divided into a plurality of segments, each segment comprising a light source arrangement to generate light with at least a first and a second color, said method comprising:
showing one color image, with the LCD arrangement, within a time period equal to a frame, wherein said frame is divided into a plurality of fields;
during each field, in each segment, driving the light source arrangement to produce light of only one of said at least first and second colors;
during each field, producing light with light source arrangements in different segments such that any of said at least first and second colors lights up in at least one segment; and
during at least one field, driving the light source arrangements in said segments are driven to produce light in accordance with a different color driving scheme than during at least one other field during said frame.

12. The method according to claim 11, further comprising, during said frame, driving the light source arrangements in said segments to consecutively produce all of said at least first and second colors within each segment.

13. A color LCD arrangement comprising:
a lower substrate;
an upper substrate;
liquid crystal material located between the lower substrate and the upper substrate; and
a backlight unit having light sources and being divided into a plurality of segments, each of the segments having a light source arrangement operative to generate light with at least a first color and a second color, the light sources being operative to be driven such that, during different fields within a frame, different color driving schemes for the segments are used.
